(19) United States
(12) Patent Application Publication
(10) Pub. No.: US 2006/0036855 A1
(43) Pub. Date: Feb. 16, 2006

(54) Short-range authentication

(75) Inventor: Ari-Pekka Simonen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/915,007

(22) Filed: Aug. 10, 2004

(51) Int. Cl. H04L 9/00

(52) U.S. Cl. 713/168

(57) ABSTRACT

System, devices and method for authentication are disclosed. The system includes a first device having data stored therein and a second device adapted to receive an authentication request signal. The authentication request signal is associated with the first device. The second device is further adapted to transmit an authentication signal in response to the authentication request signal. The first device and the second device are adapted to be carried by a user, and the authentication request signal and the authentication signal are wireless signals.

### BACKGROUND OF THE INVENTION

The present invention relates generally to the field of authentication, and particularly to systems and methods of authenticating a first device via short-range communication with a second device.

Credit card fraud and theft have become increasingly more commonplace. Such fraud and theft results in the victimization of not only the card holder, but also the credit-card companies, the merchants and the general public. The card holder becomes a victim if the stolen card results in financial losses and damage to the credit profile. Credit-card companies and merchants often must absorb the costs of the fraud and theft. These costs are ultimately passed down to the general public in the form of higher prices for goods and services.

### SUMMARY OF THE INVENTION

One embodiment of the invention relates to a system for authentication. The system includes a first device having data stored therein and a second device adapted to receive an authentication request signal. The authentication request signal is associated with the first device. The second device is further adapted to transmit an authentication signal in response to the authentication request signal. The first device and the second device are adapted to be carried by a user, and the authentication request signal and the authentication signal are wireless signals.

In another embodiment, a portable authentication device includes a receiver adapted to receive a short-range wireless authentication request signal, a processor adapted to determine whether the authentication request signal corresponds to another portable device associated with the authentication device, and a transmitter adapted to transmit a short-range wireless authentication signal when the processor determines the authentication request signal corresponds to an associated device.

In still another embodiment, a transaction terminal includes a data reader adapted to interface with a user-associated device, a transmitter adapted to transmit a short-range wireless request signal requesting authentication of the user-associated device, and a receiver adapted to receive a short-range wireless authentication signal associated with the user-associated device. The transaction terminal may also include an authentication module adapted to determine whether the authentication signal authenticates the user-associated device.

In another embodiment, a method of authenticating a portable user-associated device includes obtaining data from the user-associated device, transmitting a short-range authentication request signal based on data received from the user-associated device, and receiving a short-range authentication signal from an authentication device in response to the authentication request signal.

### BRIEF DESCRIPTION OF THE DRAWINGS

FIG. 1 is a diagrammatic illustration of an embodiment of a system for authentication of a device, such as a credit card;

FIG. 2 is a schematic illustration of an embodiment of an authenticating device shown in FIG. 1;

FIG. 3 is a schematic illustration of an embodiment of a transaction terminal shown in FIG. 1; and

FIG. 4 is a flow chart illustrating an embodiment of an authentication process.

### DETAILED DESCRIPTION OF THE PREFERRED EMBODIMENTS

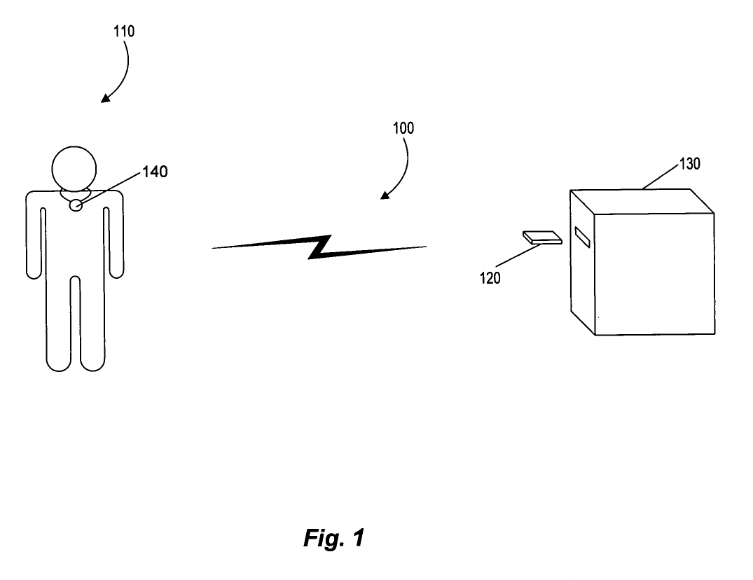

Referring to FIG. 1, an authentication system 100 according to an embodiment of the invention is illustrated. A user 110 is shown as having presented a user-associated device 120, such as a credit card, to a transaction terminal 130.

The user-associated device 120 may be any of a variety of devices. For example, in addition to credit cards, the user-associated device 120 may be a debit or other type of card or a portable device, such as a cellular phone, with credit-card functionality. In other embodiments, the user-associated device 120 may be a form of identification user, for example, in gaining access to restricted areas or unlocking an electronic device such as a mobile phone.

The transaction terminal 130 may be an automated teller machine (ATM), a cash register or other device adapted to interface with the user-associated device 120. In other embodiments, the transaction terminal 130 may include a card reader for controlling access to a restricted area, for example. On embodiment of a transaction terminal is described in further detail below with reference to FIG. 3.

When the user-associated device 120 interfaces with the transaction terminal 130, the transaction terminal 130 reads data stored on the user-associated device. The data may be read from a magnetic stripe on the user-associated device 120, for example. In other embodiments, the user-associated device 120 includes an integrated circuit having a memory device for storing the data. The data may include such information as the credit-card number or an identification number of the user 110. The data may also include authentication information for authenticating the user-associated device 120.

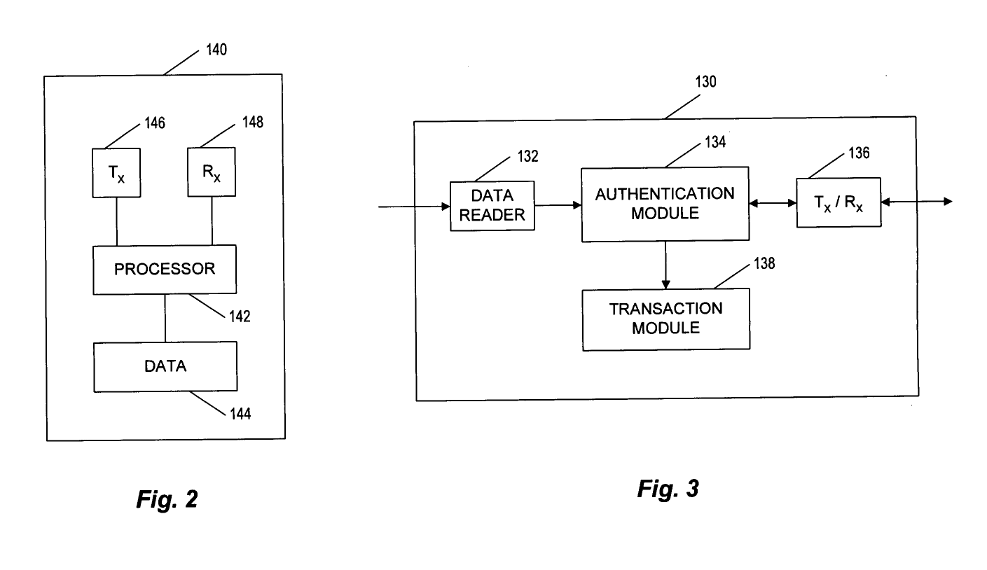

The interfacing of the user-associated device 120 and the transaction terminal 130 causes an authentication request signal to be transmitted. In one embodiment, the user-associated device 120 includes a transmitter for transmitting the authentication request signal. In other embodiments, as described below with reference to FIG. 2, the authentication request signal is transmitted by the transaction terminal 130.

The authentication request signal is encoded for transmission using a protocol adapted for short-range, wireless communication. One such protocol is commonly known as Bluetooth. For details on the Bluetooth protocol, reference may be made to www.bluetooth.org.

The authentication request signal is received by an authenticating device 140 carried by the user 110. The authenticating device 140 includes a receiver and a transmitter for short-range communication. An embodiment of the authenticating device 140 is described below with reference to FIG. 2. The authenticating device 140 may be any portable device capable of wireless short-range communication. In one embodiment, as illustrated in FIG. 1, the authenticating device 140 may be worn by the user 110 as jewelry. In other embodiments, the authenticating device 140 may be implemented within other portable devices, such as cellular phones, personal digital assistants, etc.

In response to the authentication request signal, the authenticating device 140 transmits an authentication signal authenticating the user-associated device 120. As with the authentication request signal, the authentication signal is encoded for transmission using a protocol adapted for short-range, wireless communication, such as Bluetooth.

Thus, a credit card, for example, cannot be used unless a corresponding authenticating device is nearby. In this regard, even if the credit card is stolen, it cannot be used unless it is accompanied by the authenticating device.

Referring now to FIG. 2, an embodiment of the authenticating device 140 will be described. The authenticating device 140 includes a receiver 148 for receiving short-range, wireless signals, such as authentication request signals. The received signal is decoded by a processor 142, which determines whether the received signal corresponds to another portable device that is associated with the authenticating device 140. This determination may be made by using data stored within the authenticating device 140 and comparing the data to data included in the received signal. The data stored in the authenticating device 140 may be stored in a memory device 144. If the processor 142 determines that the received signal corresponds to an associated device, the processor 142 causes a transmitter 146 to transmit an authentication signal. As noted above, the authentication request signal and the authentication signal are short-range signals and may be encoded for transmission using a protocol such as Bluetooth.

Referring now to FIG. 3, an embodiment of a transaction terminal 130 of FIG. 1 is illustrated. The transaction terminal 130 includes a data reader 132 adapted to interface with a user-associated device, such as a credit card. The data reader 132 may be adapted to read data from a magnetic stripe or from an integrated circuit or memory device within the user-associated device. An authentication module 134 receives the data read by the data reader 132. The authentication module 134 may be adapted to determine whether the particular user-associated device requires authentication. If authentication is required, a short-range wireless authentication request signal may be transmitted using a transmitter/receiver 136 of the transaction terminal 130. If an authentication signal is received in response, the received signal can be decoded by the authentication module 134, which is adapted to determine whether the received signal authenticates the user-associated device. If the received signal is determined to have authenticated the user-associated device, control of the transaction may be passed to a transaction module 138. If the user-associated device cannot be authenticated, the transaction may be aborted and the user notified accordingly.

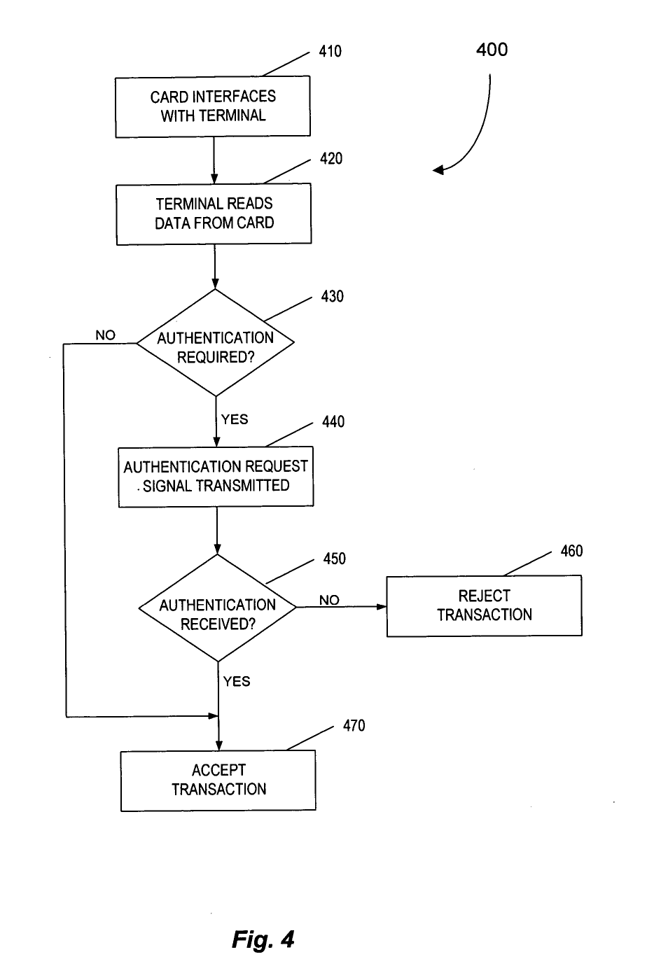

FIG. 4 is a flow chart illustrating an embodiment of an authentication process. The authentication process 400 begins when a user-associated device, such as a credit card, interfaces with a transaction terminal (block 410). At block 420, data from the user-associated device is obtained by the transaction terminal. The data may be obtained by reading the data from a magnetic stripe. In other embodiments, the user-associated device may transmit the data for receipt by the transaction terminal.

At block 430, the transaction terminal determines whether the user-associated device requires authentication. If no authentication is required, as may be the case if a credit-card does not include appropriate security protection, the process proceeds to block 470 and accepts the transaction. If, at block 430, the determination is made that the user-associated device requires authentication, an authentication request signal is transmitted by the transaction terminal (block 440). In other embodiments, as described above, the authentication request signal may be transmitted by a transmitter in the user-associated device.

At block 450, the transaction terminal determines whether the user-associated device has been authenticated. In this regard, a predetermined length of time may be allowed for an authentication signal to be received. For example, if no authentication signal is received within 30 seconds, the transaction terminal may conclude that no authentication has been received. In such cases, the process proceeds to block 460 and rejects or aborts the transaction.

If an authentication signal is received and the transaction determines that the received signal authenticates the user-associated device, the process proceeds to block 470, and the transaction is accepted.

Thus, the above-described systems, devices and methods provide protection against theft or fraud related to such devices as credit cards or other financial instruments, as well as for devices such as identification devices used to restrict entry to certain areas or buildings, for example.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A system for authentication, comprising:
a first device having data stored therein; and
a second device adapted to receive an authentication request signal, the authentication request signal being associated with the first device, the second device being further adapted to transmit an authentication signal in response to the authentication request signal;
wherein the first device and the second device are adapted to be carried by a user; and
wherein the authentication request signal and the authentication signal are wireless signals.

2. The system of claim 1, wherein the first device includes a transmitter for transmitting the authentication request signal.

3. The system of claim 2, wherein the first device includes a receiver for receiving the authentication signal.

4. The system of claim 1, wherein the first device is adapted to interface with a transaction terminal.

5. The system of claim 4, wherein the first device is adapted to cause the transaction terminal to transmit the authentication request signal.

6. The system of claim 4, wherein interfacing of the first device with the transaction terminal causes the transaction terminal to transmit the authentication request signal.

7. The system of claim 1, wherein the first device is a credit card.

8. The system of claim 1, wherein the first device is a wireless device.

9. The system of claim 1, wherein the second device is a wireless device.

10. The system of claim 9, wherein the second device is a cellular phone.

11. The system of claim 9, wherein the second device is adapted to be worn as jewelry.

12. The system of claim 1, wherein the second device includes a processor adapted to determine whether the authentication request signal properly identifies the first device.

13. The system of claim 1, wherein the authentication request signal and the authentication signal are transmitted using a short-range protocol.

14. The system of claim 13, wherein the short-range protocol is Bluetooth.

15. A portable authentication device, comprising:
a receiver adapted to receive a short-range wireless authentication request signal;
a processor adapted to determine whether the authentication request signal corresponds to another portable device associated with the authentication device; and
a transmitter adapted to transmit a short-range wireless authentication signal when the processor determines the authentication request signal corresponds to an associated device.

16. The authentication device of claim 15, wherein the authentication request signal and the authentication signal are transmitted using a short-range protocol.

17. The authentication device of claim 16, wherein short-range protocol is Bluetooth.

18. A transaction terminal, comprising:
a data reader adapted to interface with a user-associated device;
a transmitter adapted to transmit a short-range wireless request signal requesting authentication of the user-associated device; and
a receiver adapted to receive a short-range wireless authentication signal associated with the user-associated device.

19. The transaction terminal of claim 18, further comprising an authentication module adapted to determine whether the authentication signal authenticates the user-associated device.

20. The transaction terminal of claim 18, wherein the request signal and the authentication signal use a short-range protocol.

21. The transaction terminal of claim 20, wherein short-range protocol is Bluetooth.

22. A method of authenticating a portable user-associated device, comprising:
obtaining data from the user-associated device;
transmitting a short-range authentication request signal based on data received from the user-associated device; and
receiving a short-range authentication signal from an authentication device in response to the authentication request signal.

23. The method of claim 22, wherein the user-associated device is a credit card.

24. The method of claim 22, wherein the user-associated device is a wireless device.

25. The method of claim 22, wherein the authentication device is a wireless device.

26. The method of claim 25, wherein the authentication device is a cellular phone.

27. The method of claim 25, wherein the authentication device is adapted to be worn as jewelry.

28. The method of claim 22, wherein the authentication request signal and the authentication signal are transmitted using a short-range protocol.

29. The method of claim 28, wherein the short-range protocol is Bluetooth.
